(19) United States
(12) Patent Application Publication
(10) Pub. No.: US 2026/0039511 A1
(43) Pub. Date: Feb. 5, 2026

(54) ARTIFICIAL INTELLIGENCE BASED CHANNEL ESTIMATION IN WIRELESS COMMUNICATION SYSTEMS

(71) Applicant: Samsung Electronics Co., Ltd., Suwon-si (KR)

(72) Inventors: Mandar Kulkarni, Bridgewater, NJ (US); Fan Zhang, Plano, TX (US); William Xia, Ozone Park, NY (US); Van Thuy Nguyen, Plano, TX (US); Yan Xin, Princeton, NJ (US); Yang Li, Plano, TX (US); Jianzhong Zhang, Dallas, TX (US)

(21) Appl. No.: 19/169,981

(22) Filed: Apr. 3, 2025

Related U.S. Application Data
(60) Provisional application No. 63/677,940, filed on Jul. 31, 2024.

(51) Int. Cl. H04L 25/02

(52) U.S. Cl. CPC H04L 25/0204; H04L 25/0242; H04L 25/0254

(57) ABSTRACT

Apparatuses and methods include: receiving, by a first electronic device, a signal from a second electronic device on a channel, the received signal modified by a noise, the channel associated with a channel matrix for multiple antennas; buffering antenna data from the multiple antennas; obtaining a noisy channel based on the buffered antenna data and a least squares estimate of the channel matrix; preprocessing the noisy channel jointly across the multiple antennas; inputting the preprocessed noisy channel to a channel estimation model trained to denoise the preprocessed noisy channel; and estimating the channel matrix based on denoising of the preprocessed noisy channel.

### CROSS-REFERENCE TO RELATED APPLICATION AND CLAIM OF PRIORITY

The present application claims priority under 35 U.S.C. § 119 (e) to U.S. Provisional Patent Application No. 63/677,940 filed on Jul. 31, 2024, which is hereby incorporated by reference in its entirety.

### TECHNICAL FIELD

This disclosure relates generally to wireless communication systems. More specifically, this disclosure relates to artificial intelligence (AI) based channel estimation in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides a method and system for AI aided channel estimation in wireless communication systems.

In one embodiment, a method of channel estimation is provided. The method includes: receiving, by a first electronic device, a signal from a second electronic device on a channel, the received signal modified by a noise, the channel associated with a channel matrix for multiple antennas; buffering antenna data from the multiple antennas; obtaining a noisy channel based on the buffered antenna data and a least squares estimate of the channel matrix; preprocessing the noisy channel jointly across the multiple antennas; inputting the preprocessed noisy channel to a CE model trained to denoise the preprocessed noisy channel; and estimating the channel matrix based on denoising of the preprocessed noisy channel.

In another embodiment, a first electronic device includes a memory and a processor operably coupled to the memory. The processor is configured to receive a signal from a second electronic device on a channel, the received signal modified by a noise, the channel associated with a channel matrix for multiple antennas; buffer antenna data from the multiple antennas; obtain a noisy channel based on the buffered antenna data and a least squares estimate of the channel matrix; preprocess the noisy channel jointly across the multiple antennas; input the preprocessed noisy channel to a CE model trained to denoise the preprocessed noisy channel; and estimate the channel matrix based on denoising of the preprocessed noisy channel.

In yet another embodiment, a non-transitory computer readable medium embodying a computer program is provided. The computer program includes program code that, when executed by a processor of a first electronic device, causes the first electronic device to: receive a signal from a second electronic device on a channel, the received signal modified by a noise, the channel associated with a channel matrix for multiple antennas; buffer antenna data from the multiple antennas; obtain a noisy channel based on the buffered antenna data and a least squares estimate of the channel matrix; preprocess the noisy channel jointly across the multiple antennas; input the preprocessed noisy channel to a CE model trained to denoise the preprocessed noisy channel; and estimate the channel matrix based on denoising of the preprocessed noisy channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates an example sounding reference signal (SRS) based channel estimation procedure according to embodiments of the present disclosure;

FIG. 6 illustrates an example frequency hopping SRS mode according to embodiments of the present disclosure;

FIG. 7 illustrates an example 5G NR uplink orthogonal frequency division multiplexing slot structure to embodiments of the present disclosure;

FIG. 8 illustrates an example timing offset impairment in wireless communication systems according to embodiments of the present disclosure;

FIG. 9 illustrates a flow diagram of an AI-based channel estimation method according to embodiments of the present disclosure;

FIG. 10 illustrates an example AI model for performing channel estimation according to embodiments of the present disclosure;

FIG. 11 illustrates a flow diagram of an example training data preprocessing according to embodiments of the present disclosure;

FIG. 12 illustrates an example noisy channel preprocessing according to embodiments of the present disclosure;

FIG. 13 illustrates an exemplary time domain windowing operation for AI-based channel estimation (CE) according to embodiments of the present disclosure;

FIG. 14 illustrates an example operation of an end-to-end AI CE pipeline for different radio resource control (RRC) configuration settings according to embodiments of the present disclosure;

FIG. 15 illustrates an example operation of an end-to-end AI CE pipeline for different RRC configuration settings according to embodiments of the present disclosure;

FIG. 16 illustrates an example operation of an end-to-end AI CE pipeline for different RRC configuration settings according to embodiments of the present disclosure;

FIG. 17 illustrates an example pixel shuffle downsampling for AI CE models according to embodiments of the present disclosure;

FIG. 18 illustrates an example adaptation of an AI CE model according to embodiments of the present disclosure;

FIG. 19 illustrates example retraining of native AI models according to embodiments of the present disclosure; and

FIG. 20 illustrates an example flow chart for an AI-based CE method according to embodiments of the present disclosure.

### DETAILED DESCRIPTION

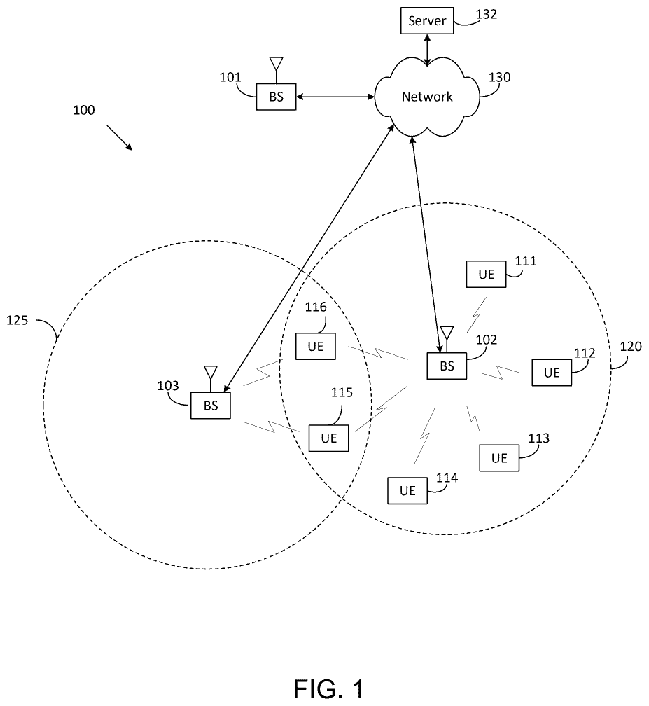

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an AI-based cellular system. As such, the at least one network 130 may be operably coupled to a network device (e.g., without limitation, a server) 132 configured to, for example and without limitation, train and/or test an AI model (also referred to herein as an “AI channel estimation (CE) model”). When the AI CE model performs CE based on sounding reference signal (SRS), the AI CE model may be also referred to herein as an “SRS AI CE model” or “AI SRS-based CE model”. The server 132 may represent one or more servers, and each server 132 includes a suitable computing or processing device for. Each server 132 could, for example, include one or more processing devices, one or more memories storing instructions and data, and one or more network interfaces to receive the data from, e.g., without limitation, gNBs 101-103.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform wireless communications tasks using the AI CE model.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

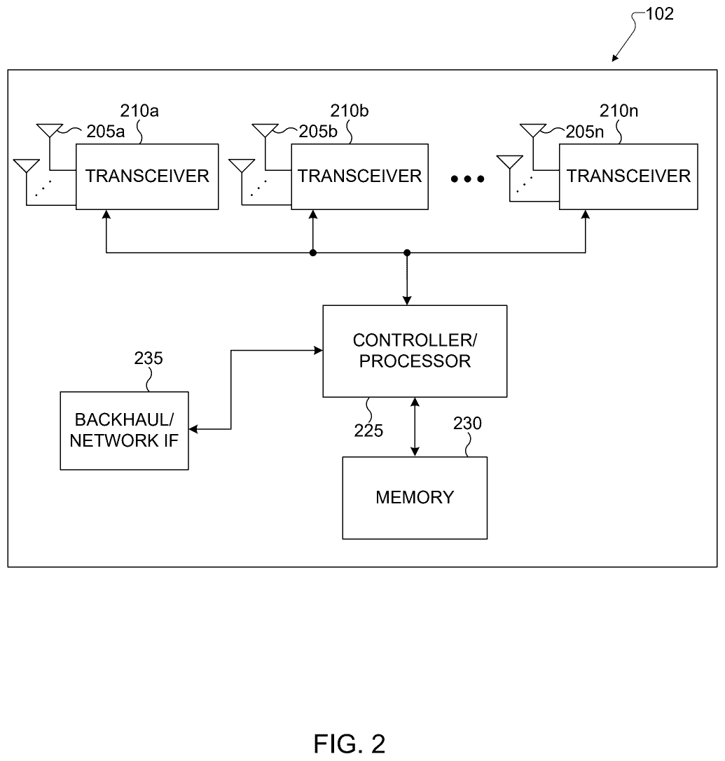

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI aided channel estimation as discussed further in detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

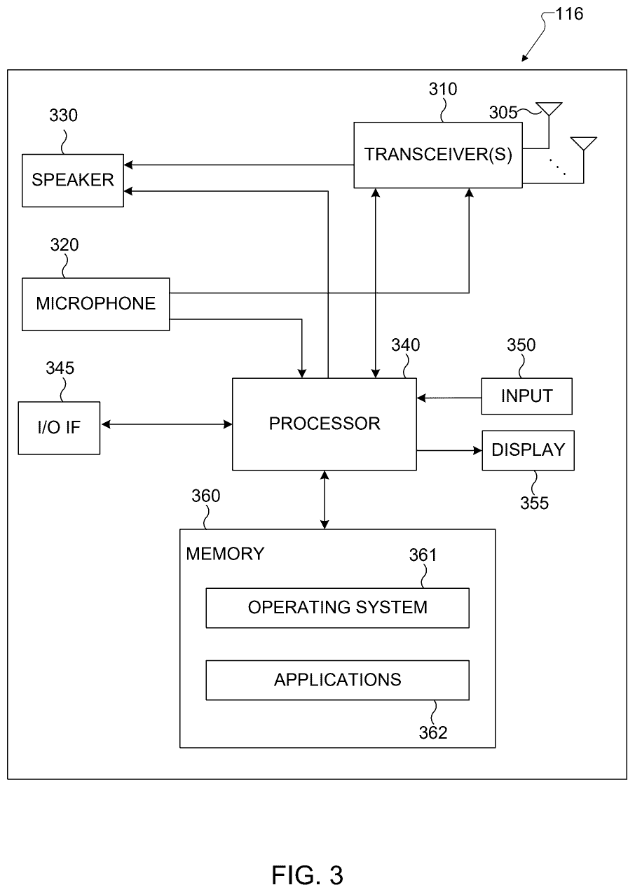

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support the AI-aided channel estimation method as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

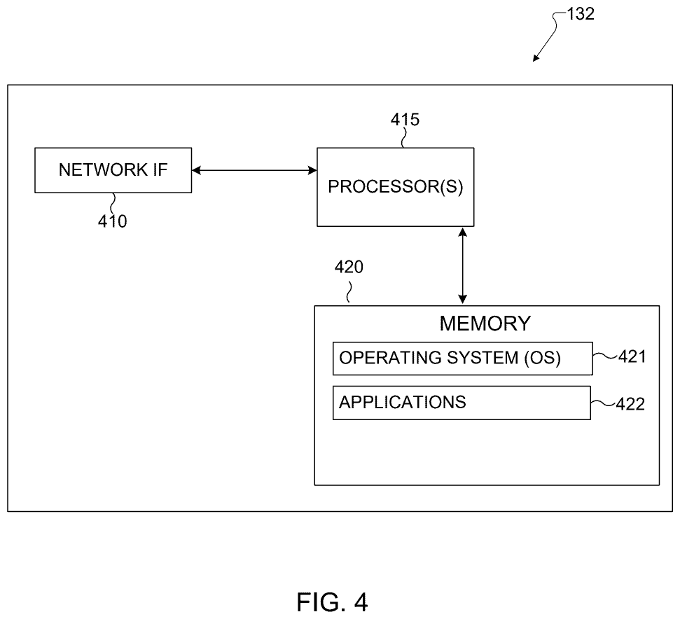

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also train an AI CE model to perform channel estimation as discussed further in detail below.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as the channel estimation model as well as a CPU, a GPU or a tensor processing unit (TPU) that provides significant computational resources required for training the AI CE model.

The processor 415 is also capable of executing other processes and programs resident in the memory 420, such as operations that receive and store data. As described in greater detail below, the processor 415 may execute processes to receive data from the gNBs 101-103, the UEs 111-116 or any other appropriate sources and train and/or test the AI CE model. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training and/or testing application for the AI CE model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

Each of these discussed transmitted, received, and/or calculated parameters or metrics are examples of data that is generated at the base station and/or UE that may be utilized in AI-based channel estimation in wireless communication systems in various embodiments of the present disclosure.

In modern wireless systems, such as those described regarding FIGS. 1-4 native AI algorithms for physical and medium access layer have been utilized to drive the next generation cellular network design. However, some deployments of the AI algorithms to commercial products have not yet been realized due to various engineering problems that may be need to be solved for this paradigm shift to occur. For example, in wireless communication systems, accurate channel estimation is instrumental in uplink and downlink throughput (Tput) performance since the channel estimation is utilized for unlink channel aware scheduling, precoder matrix index (PMI) selection and so forth. However, some channel estimation solutions do not provide a reliable and efficient channel estimation performance due to various radio frequency impairments. Nor are they capable of handling abrupt changes in signal configurations or different types of RRC configurations for the SRS. Further, some models are trained with fixed data that may not reflect any changes or updates that are specific to areas of interests, significantly compromising the performance and accuracy thereof.

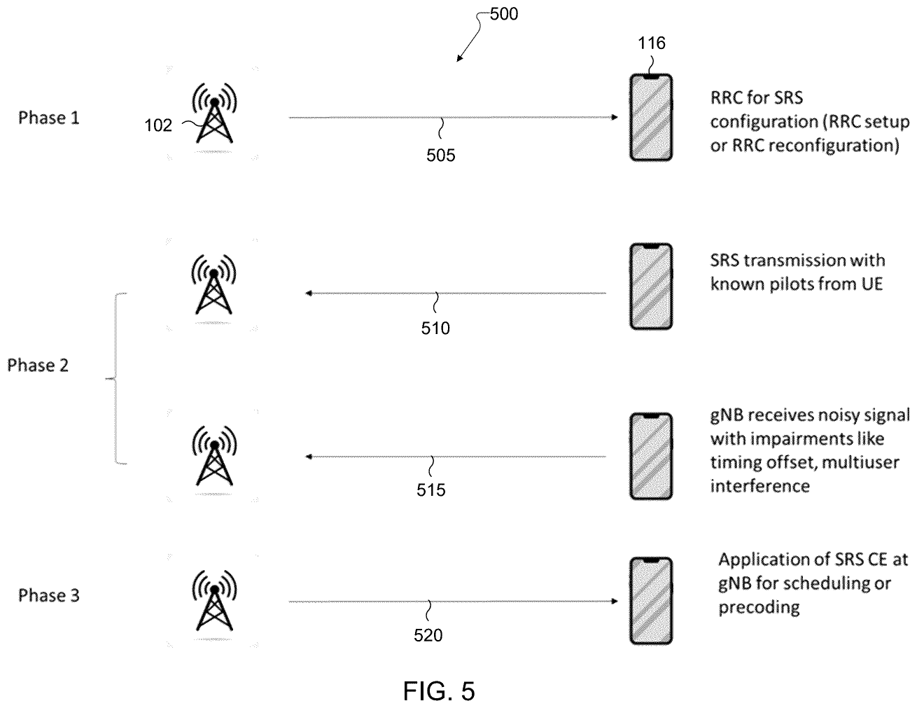

The present disclosure provides apparatuses and methods of training, testing and deploying an AI CE model that effectively resolves these issues (as discussed in greater detail below.). FIGS. 5-20 illustrate the AI based CE methods and apparatuses as well as related concepts in detail.

FIG. 5 illustrates an example SRS based channel estimation procedure 500 according to embodiments of the present disclosure. As illustrated in FIG. 5, the channel estimation may be performed in three phases.

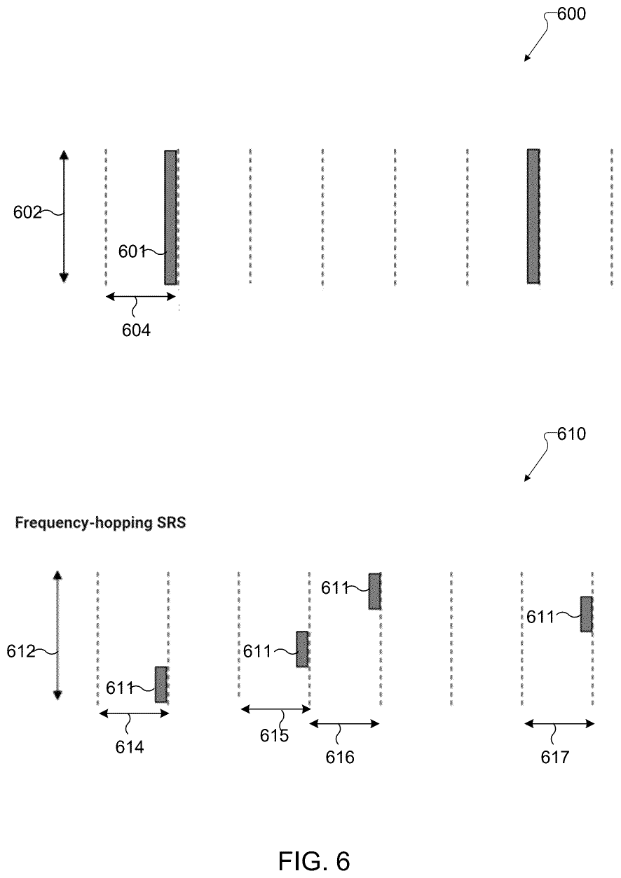

In phase 1, a base station (e.g., without limitation, the base station 101-103 of FIGS. 1 and 2) may transmit an RRC signal 505 for configuring or reconfiguring SRS in terms of a total number of resource blocks (RBs) for SRS transmission, a frequency bandwidth of operation, a frequency hopping option, and transmission comb and cyclic shift information. As illustrated in FIG. 6, the frequency hopping option may allow the UEs (e.g., without limitation, the UEs 111-116 of FIGS. 1 and 3) to transmit SRSs in a frequency hopping mode when the channels may have poor conditions. The transmission comb and cyclic shift may provide ways to multiplex multiple users. Cyclic shift may indicate the number of users which can be scheduled at the same RBs simultaneously, exploiting the delay domain orthogonality of the signal. Transmission comb N may indicate whether the SRS may be transmitted over every N^{th} subcarrier.

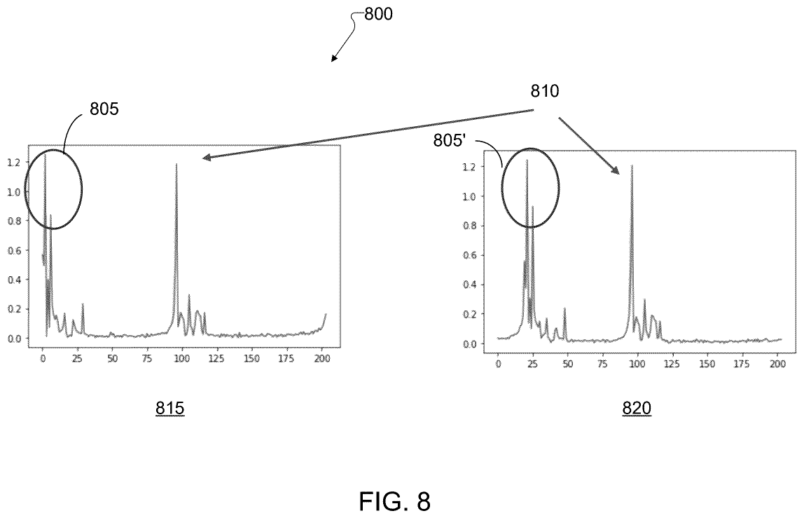

In phase 2, the UEs may transmit SRSs 510 as per corresponding configuration from the serving base station, and the base station may receive noisy versions 515 of the SRSs. The noisy signal may be impaired with, e.g., without limitation, timing offset, multiuser inferences (as shown in FIG. 8). The base station may then perform channel estimation based on the received signals and its knowledge of known pilot symbols that were transmitted.

In phase 3, the base station may utilize the estimated channels from the SRSs for the following example applications:
1. Uplink channel aware scheduling and link adaptation:
   a. The packet scheduler identifying the best set of RBs to schedule the user
   b. Utilizing an uplink signal to interference plus noise ratio (estimated from the estimated channel) as an input for link adaptation (i.e. modulation and coding scheme (MCS) also known as MCS adjustment).
2. Downlink application: If the UE has an antenna switching capability to use the RX antennas for TX and vice versa, then for a TDD system the channel estimated using the uplink SRS can also be used for downlink. In this case, the UE may actually use the antennas it will be using for downlink reception for transmitting the uplink SRS signals leveraging the antenna switching.
3. Uplink beam management: A user may be allowed to choose the best uplink beam at the best station using the estimated channel.

Although the user specific reference signals may be transmitted over the entire bandwidth of operation, the channels may have a bad channel quality, requiring different operation mode as illustrated in FIG. 6.

FIG. 6 illustrates example frequency operation modes for transmitting SRS according to example embodiments of the present disclosure.

In a full-band mode 600, the SRS 601 may be transmitted over a full bandwidth 602 in the assigned slot(s) of a single orthogonal frequency division multiplexing (OFDM) subframe 604. When the channel conditions are poor, a frequency hopping mode 600 may be utilized for transmitting the SRS 611. The frequency hopping mode option may allow the UEs to enable “frequency hopping,” where the entire bandwidth 612 of operation may be covered not in a single OFDM subframe but across multiple subframes 614-617.

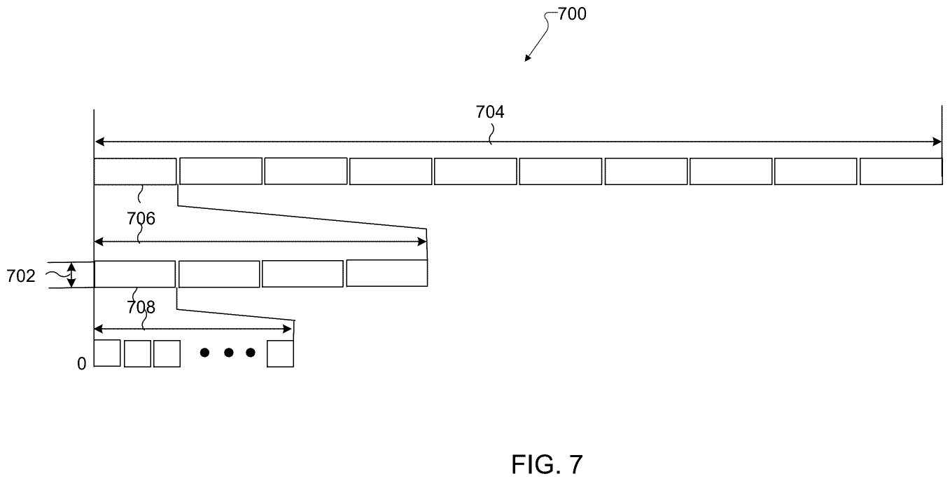

FIG. 7 illustrates an example 5G NR uplink OFDM slot structure 700 according to embodiments of the present disclosure.

In 5G NR, different numerologies are supported that may have different subcarrier spacings, slot duration and a number of slots per subframe.

As illustrated in the example of FIG. 7, a subcarrier 702 may have a frequency bandwidth of 60 Hz. A radio frame 704 may include 10 subframes. A subframe 706 may have a duration of 1 ms and include four OFDM slots 708. An OFDM slot 708 may have a duration of 0.25 ms and include 14 symbols. The SRS may occupy 1, 2 or 4 slots in the last 6 slots of a subframe.

SRS-based channel estimation may be defined as estimating a channel H_{N}_{_{sc}}_{×N}_{ₐₙₜ} given received noisy SRS signals Y_{N}_{_{sc}}_{×N}_{ₐₙₜ}. The received noisy signal Y_{N}_{_{sc}}_{×N}_{ₐₙₜ} may be provided as follows:

$${Y}_{{N}_{s c} \times {N}_{a n t}} = {H}_{{N}_{s c} \times {N}_{a n t}} {oX}_{{N}_{s c} \times {N}_{a n t}} + {N}_{{N}_{s c} \times {N}_{a n t}} \qquad ( Eq . 1 )$$

where o represents element wise multiplication. The transmitted SRS pilots may contain known Zadoff Chu sequences X_{N}_{_{sc}}_{×N}_{ₐₙₜ}. The Zadoff Chu sequence may then be removed or decorrelated at the receiver, yielding the least squares estimate Z of the channel. The noisy channel estimate Z can be provided as:

$$Z = \frac{Y}{X} = H + N .$$

Channel estimation is, thus, denoising this noisy channel estimate.

Denoising can be typically performed utilizing the linear minimum mean squared error estimate (LMMSE). However, the complexity of the LMMSE becomes prohibitively high as the antenna dimensions and subcarrier dimensions increase. Thus, the moving average algorithm (also referred to herein as the moving average (MA) baseline algorithm) that has lower complexity than the LMMSE and exploits the high correlation across the subcarriers can be utilized to denoise the noisy channel estimate.

Some AI-based channel estimation solutions may include a supervised learning approach in which the AI model may be first trained with perfect labels and noises. The loss function during the training may minimize the difference between the output of the AI model and the perfect labels with respect some metrics such as the mean squared error. However, the number of parameters can be in the order of 10s of thousands to 100s of thousands for a small to medium sized network. Once the model parameters are learned, the AI model may undergo the testing phase during which the noises, but not the perfect labels, may be fed to the model again and produce a denoised output, utilizing the learned model parameters. While such AI-based channel estimation solutions have been investigated in the academic literature, their practical deployments are not yet available due to numerous unresolved engineering problems related to the model training, performance, complexity and generalizability. One of those problems can be timing offset impairment as shown in FIG. 8.

FIG. 8 illustrates an example timing offset impairment 800 in channel estimation according to embodiments of the present disclosure. The x-axis indicates the delay taps (each delay tap representing 40.85 ns delay), and the y-axis indicates the signal amplitudes.

In general, timing advance (TA) may be used to control the uplink transmission timing of UEs including SRSs, PUSCH or PUCCH. A base station may transmit a TA command to UEs so that the signals from all of the UEs may arrive synchronously across different RBs. If there is a cyclic shift configuration, then certain UE signal may be expected to arrive at a predefined delay as compared to the start of the symbol. However, due to hardware impairments such as a clock drift between the UEs and the base station, UE mobility or inaccuracy of the TA command, the signal does not exactly arrive at the expected time. The offset between the actual time the signal arrived and the expected time it should have arrived is called the timing offset (TO).

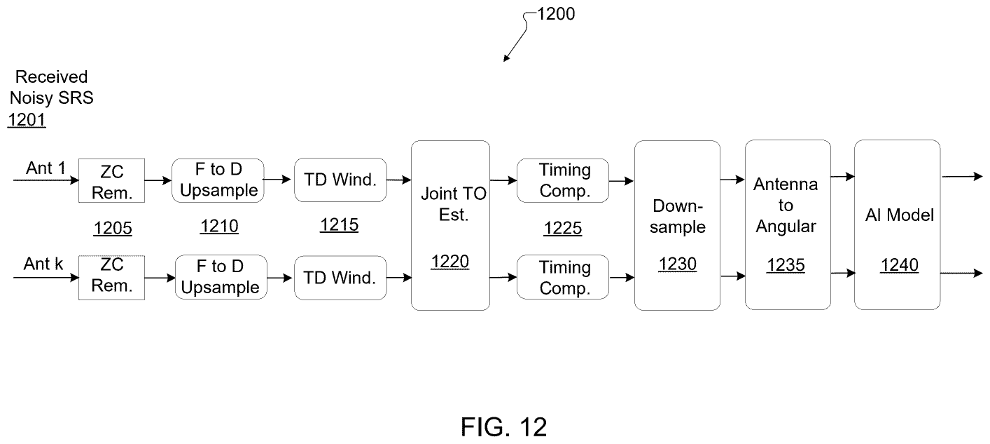

In FIG. 8, the TO impairment in a cyclic-shift (CS) 2 scenario is illustrated. That is, there may be one interfering UE 810 for a target channel (UE). In the graph 815, there may be no TO for the SRS 805 transmitted over the targe channel. In graph 820, the SRS 805′ transmitted over the target channel may encounter a 780 ns TO (40.85 ns×19 delay taps) impairment. The interfering UE signal 810 may be separated from a target channel in a delay domain by dividing the total OFDM symbol duration for the SRS transmission into equal halves as discussed with reference to FIG. 12.

It is noted that in the present disclosure, the key performance indicator (KPI) may be the normalized mean squared error (NMSE) in a dB scale. Hence, the channel estimation performance may be inversely proportional to the KPI.

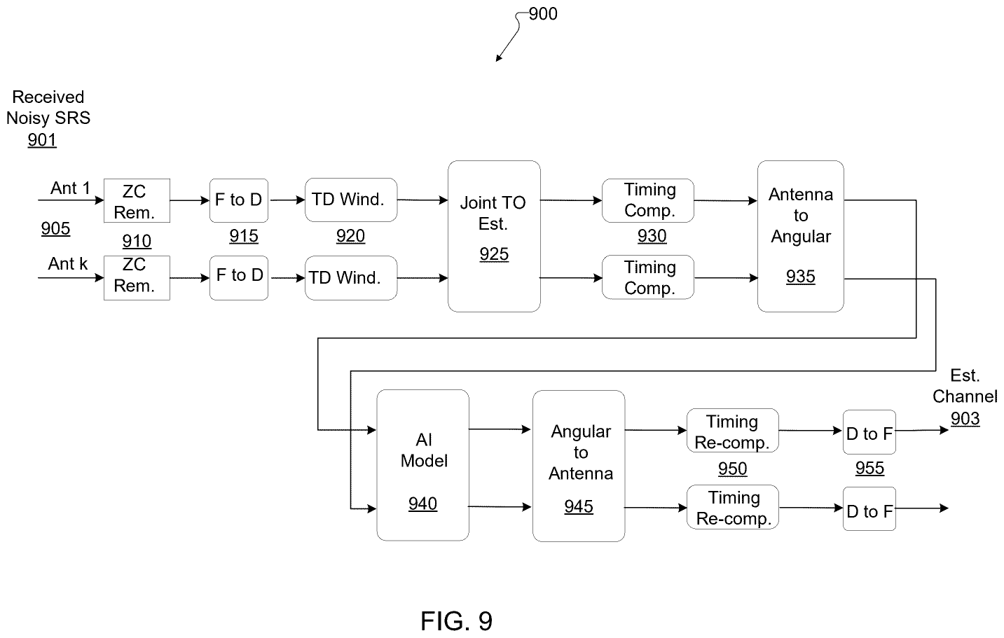

Now, the AI-based channel estimation method and apparatus according to the present disclosure, which resolve some of the aforementioned engineering problems, are discussed further in detail with reference to FIGS. 9-20.

FIG. 9 illustrates an AI-based channel estimation method 900 utilizing SRS (also referred to herein as SRS AI CE method) according to embodiments of the present disclosure.

In the example as illustrated in FIG. 9, the method 900 begins at step 905. At step 905, multiple antennas of a base station (e.g., without limitation, the base station 101-103 of FIGS. 1 and 2) may receive noisy SRS 901. The antenna data from the multiple antennas may be preprocessed. The preprocessing may be AI-friendly, e.g., including transforming the received SRS 901 into a delay domain early in the preprocessing process. The AI-friendly preprocessing may allow all of the MUI removal, TO estimation and timing compensation to be performed in the delay domain, thereby reducing complexity as compared to the preprocessing that may require additional FFT/IFFT operations to return to the frequency domain from the delay domain for the TO, and transform back to the delay domain for the timing compensation. In some examples in which the frequency TO is performed first before converting to the delay domain, the order of the MUI removal and TO may be swapped, which is not recommended from performance perspective.

At step 910, the noisy SRS 901 may undergo Zadoff-Chu sequence removal operation. As mentioned previously, the Zadoff-Chu sequence removal may be equivalent to obtaining a least squares noisy channel estimate Z (also referred to herein as a noisy channel or a noisy channel estimate).

At step 915, the noisy channel may be converted from the frequency-antenna domain to the delay-antenna domain by taking IFFT across the subcarriers. Thus, the method 900 may utilize the AI-friendly preprocessing in which the early delay domain transformation is performed.

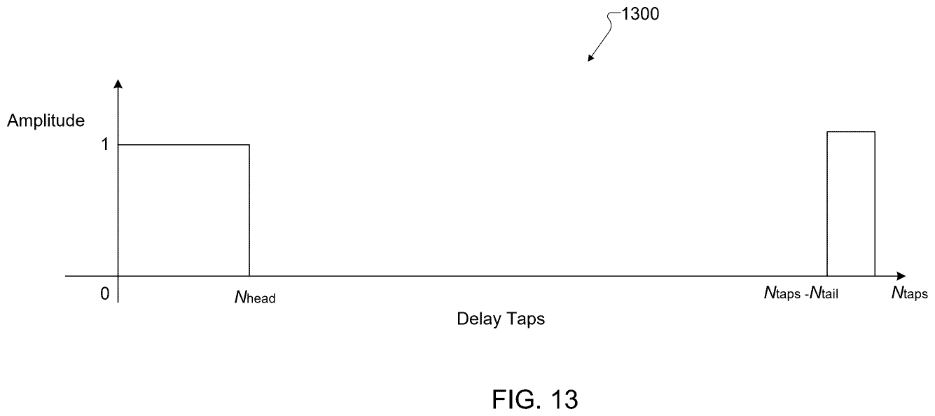

At step 920, the transformed noisy channel may be filtered by a time domain window. Through the timing domain window filtering, the target channel may be separated from a multiuser interference (MUI) in the delay-antenna domain, as described further in detail with reference to FIG. 13.

At step 925, joint antenna timing estimation may be performed in the delay domain. Some modem algorithms may employ independent TO estimation algorithm due to the corresponding advantage of not having to buffer the input channel for all of the antennas before performing the channel estimation. Since the input to the AI model may be recommended to be in the delay-angular domain, the conversion of antenna to angular domain at step 935 may suffer if a different TO is applied to each antenna data stream. That is, the model performance may significantly degrade with independent timing estimation. Performing joint timing estimation across all antennas may help improve the accuracy of the TO and ensure that while converting from the antenna to angular domain, a different TO may not be applied to each antenna, which would distort the angular domain. Although certain consumer products may implement independent timing estimation for reducing delay in SRS AI channel estimates per antenna, the delays may be non-negligible especially for large array settings. Thus, the joint antenna timing estimation may be utilized for the best SRS AI CE performance.

For the joint timing estimation, an algorithm based on center of gravity estimates (CoG) may be performed as follows:

```
•  $Input : delay domain channel \{ {h}_{D \times 1}^{1} , … , {h}_{D \times 1}^{N} \} with D delay taps and N antennas ,$
•  Algorithm:
    •  $Compute power delay profile for each antenna as {g}_{D \times 1}^{i} = {\vert {h}_{D \times 1}^{i} \vert}^{2} ,$
    • Cyclically rotate each gⁱ by D/2 delay taps,
    •  $Estimate CoG : {Ω}_{i} = {\sum }_{d = 0}^{D} d {g}^{i} [ d ] / {\sum }_{d = 0}^{D} {g}^{i} [ d ] ∀ i ∈ \{ 1 , 2 , … , N \}$
    •  $Output : timing estimate given by τ = round ( \frac{1}{N} {\sum }_{i = 1}^{N} {Ω}_{i} - \frac{D}{2} )$
```

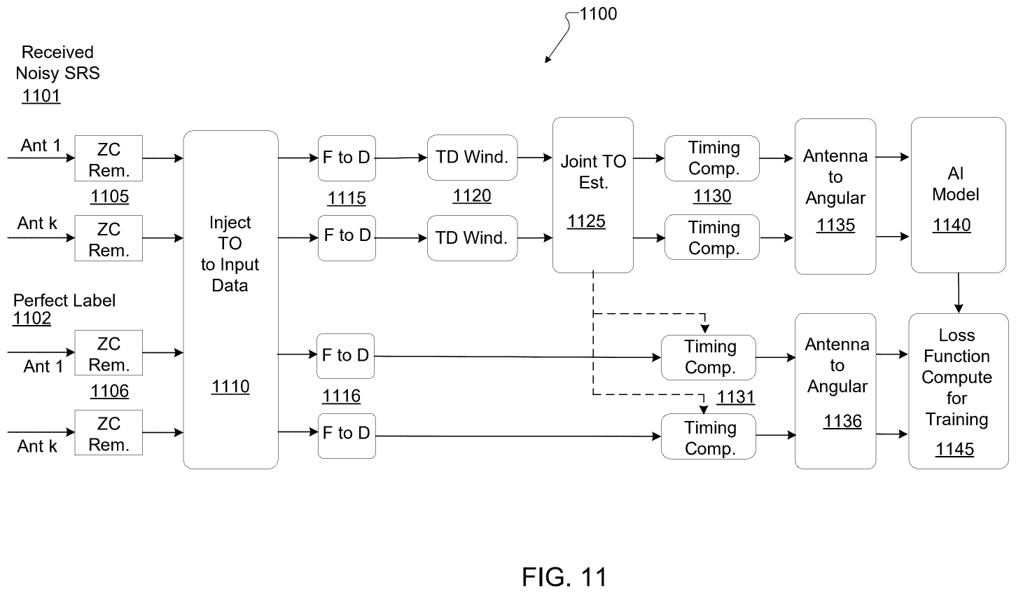

In addition to the joint antenna timing estimation, the AI-based CE may be further improved by introducing a random synthetic TO during training as shown in FIG. 11.

At step 930, the timing compensation operation may be performed on the noisy channel.

At step 935, the noisy channel may be converted from the antenna to angular domain.

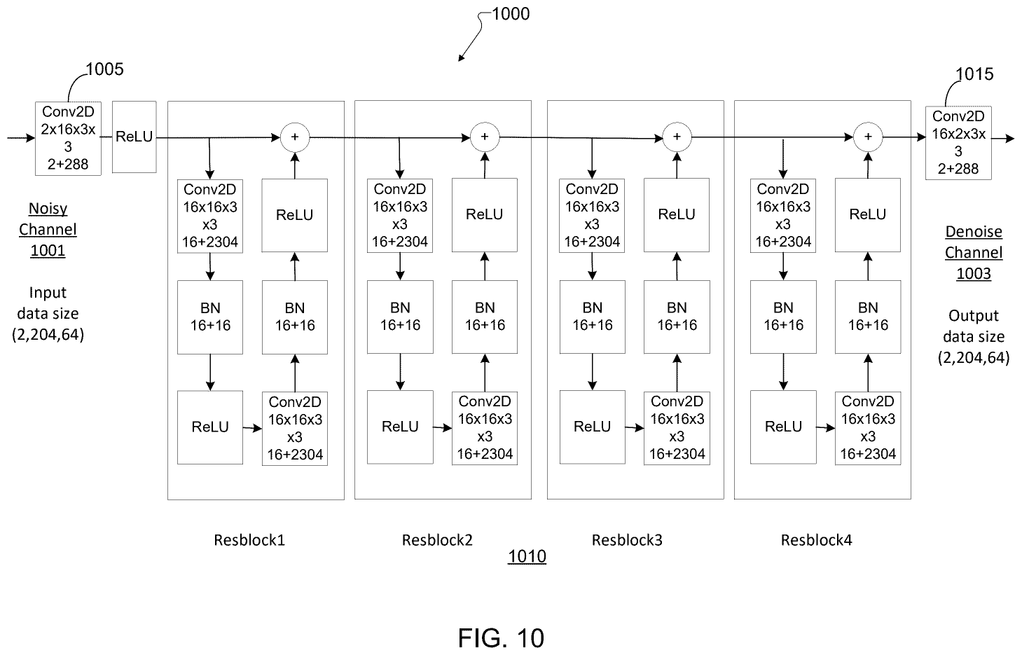

At step 940, the delay-angular domain noisy channel may be input the to AI model 940 for denoising discussed further in detail with reference to FIG. 10.

At step 945, the denoised channel may be transformed from the delay-angular domain to the delay-antenna domain.

At step 950, timing recompensation operation may be performed to the denoised channel.

At step 955, the time-recompensated channel may be transformed from the delay domain-antenna domain to the frequency-antenna domain.

At step 960, the estimated channel 903 may be output for applications.

FIG. 10 illustrates an example AI model 1000 for channel estimation according to embodiments of the present disclosure. The AI model 1000 may be also referred to as “Vanilla ResNet model.”

The AI model 1000 may be a residual neural network including two-dimensional convolution networks (Conv2D), ReLUs, and Resblocks. Each Resblock may include two sets of Conv2Ds, Batch Normalization, ReLUs and skip connection.

In FIG. 10, each Conv2D is illustrated as receiving a input channels convolved with c×d kernel and outputs b output channels. Thus, the first Conv2D 1005 may receive 2 input noisy channels convolved with 3×3 kernel and output 16 output channels. The Conv2Ds in the Resblocks 1010 may then be fed 16 input channels from the first Conv2D 1005, filtered by a 3×3 kernel and output 16 output channels. The final Conv2D 1015 may be fed 16 input channels from the last Resblock 1010, convolved with a 3×3 kernel, and output two denoised channels. The first and final Conv2Ds 1005, 1015 may have 2+288 parameters whereas the Conv2Ds in the Resblocks 1010 may have 16+2304 parameters. The input data size of the noisy channel 1001 and the output data size of the denoised channel 1003 may be the same and include two components (real and imaginary), 204 frequency or delay bins, and 64 angular bins or antennas.

However, it will be understood that the AI model 1000 as illustrated in FIG. 10 is for illustrative purposes only, and thus other types of AI models and/or components thereof may be utilized for performing channel estimation without departing from the scope of the present disclosure.

FIG. 11 illustrates an example training data preprocessing 1100 according to embodiments of the present disclosure. The preprocessing 1100 is similar to the noisy channel preprocessing operations of the AI-based channel estimation method 900, and thus the description of overlapping features or components are omitted for the sake of brevity. The preprocessing 1100 differs from the noisy channel preprocessing of the method 900 in that the former includes, for example, injecting a synthetic TO injection to the training data in order to increase the AI model's robustness to the TO impairment. The training data may include a perfect label 1102 for SRS and the received noisy SRS 1101.

Upon removal of Zadoff-Chu sequences from the training data at 1105, 1106, a processing module (e.g., a processor 225 of a base station 101-103 or a processor 415 of a network server 132) may inject a random synthetic TO at step 1110. By injecting a random TO, the processing module may ensure that the random TO follows a predetermined distribution (a uniformly distribution from −2 TA to 2 TA, for instance).

In one embodiment, with field data, the processing module may first estimate TO from a noisy channel estimate (using a non-AI algorithm) followed by adding a random TO to ensure predetermined distribution.

In one embodiment, to add a random TO, a realization of uniformly distributed random variable between, e.g., −2 TA to 2 TA, may be taken as timing offset τ to be injected, and this TO may be injected by multiplying the frequency domain noisy SRS channel by exp (−j2πfₖτ) where fₖ is the k^{th} subcarrier frequency.

In another embodiment, a coarse TO \hat{τ} may be first estimated of the target channel, and then a realization of a random variable uniformly distributed in the range from −2 TA+\hat{τ} to 2 TA+\hat{τ} may be injected. It is noted that computing \hat{τ} may first require the MUI separation step that can be done either by using the time windowing in the delay domain as illustrated in FIG. 13 or by using orthogonal cover codes in the frequency domain.

Further, for training and testing, the perfect label 1102 may be preprocessed in parallel. At step 1106, the Zadoff-Chu sequence may be removed from the label 1102, and at step 1110 the random TO may be injected to the label 1102. At step 1116, the label may be transformed from the frequency-antenna domain to the delay-antenna domain. At step 1131, the transformed label may undergo timing compensation based on the joint antenna TO estimation performed at step 1125. At step 1136, the timing compensated label may be transformed from the delay-antenna domain to the delay-angular domain. At step 1145, the processing module may compute loss function based on the denoised channel output from the AI model for training.

However, handling TOs for different channel types can still be challenging. For instance, it has been shown that a −1 TA performance may be about 5 dB worse at a high SNR as compared to 0 TA or 3 TA. This may imply that the performance of the SRS AI CE may still not be sufficiently robust to varying TOs even with an added random TO during training and the explicit handling of TO in the preprocessing chain. Such degradation in different TO settings can be identified because of leakage issue of peaky signals when converting the channel data from the frequency domain to the delay domain. In particular, if the channel is converted to the delay domain before the timing compensation, the resulting signal may look different if the signal has sharp peaks. If performed in the frequency domain with an accurate TO, the same channel with a different TO impairment may look similar after the TO compensation.

Due to certain design constraints, one may prefer having a delay domain TO estimation and compensation (for lower complexity). In such cases, oversampling of the noisy signal in the delay domain may be performed before the TO estimation and compensation so that irrespective of the original TO setting, the timing compensated channel may look similar as illustrated in FIG. 12.

FIG. 12 illustrates an example noisy channel preprocessing 1200 according to embodiments of the present disclosure. The noisy channel preprocessing 1200 is similar to the preprocessing operations of the method 900 of FIG. 9, and thus the description of overlapping features or components are omitted for the sake of brevity. The preprocessing 1200 differs from the noisy channel preprocessing of the method 900 in that the former includes, for example, upsampling of the noisy channel in the frequency domain at step 1210 and then downsampling the timing compensated noisy channel at step 1230.

Since the noisy channel (the received SRS signal) 1201 has been upsampled when converting from the frequency domain to the delay domain, the complexity of the AI model may increase due to a larger image size. Thus, the timing compensated signal may be downsampled before feeding it into the AI model to restore the decreased complexity of the AI model. For example, if the upsampling was performed by a factor of 4, then 4 candidate sequences with the original sampling rate after timing compensation may be considered. The sequence with the largest peak channel power may be selected. Such upsampling and downsampling in preprocessing may increase the robustness of the TDL-A channel performance while there is no additional performance degradation at −1 TA.

FIG. 13 illustrates an exemplary time domain windowing operation 1300 for an AI-aided channel estimation based on SRS according to embodiments of the present disclosure.

The time domain windowing may filter a target channel with cyclic shift 0. It may be assumed that there may be Nₜₐₚₛ delay taps and cycle shift C. Then, the cyclic shift 0 user (UE) may be expected to fall within the following delay taps in ideal conditions

$$- [ 0 , \frac{{N}_{taps}}{C} ] .$$

Considering that there can be a negative TO for cyclic shift 1 user, the SRS may be

$${N}_{h e a d} = \frac{{N}_{t a p s}}{C} - {N}_{buffer} .$$

Similarly, considering that the target user may have a negative TO as well, the last Nₜₐᵢₗ=N_{buffer} taps may be also included for extracting the target channel from the delay taps. In some examples, for other users multiplexed (e.g., at n^{th} cyclic shift), the transformed signal in the delay domain may be first cyclically shifted by −nNₜₐₚₛ/N_{cs} to bring the user taps of the user similar to UE 0, and then the same window may be applied.

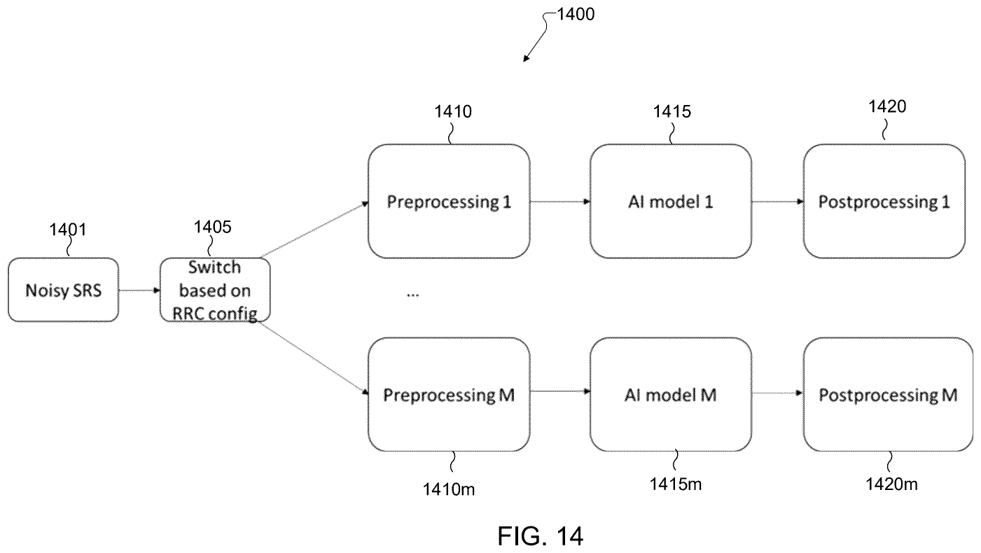

FIGS. 14-16 illustrate example operations of an end-to-end SRS AI CE pipeline 1400 for different RRC configuration settings according to embodiments of the present disclosure. While three different pipelines based on different RRC configuration settings are shown, these are for illustrative purposes only, and thus any other pipelines based on different RRC configuration settings or any combination thereof may be utilized without departing from the scope of the present disclosure.

FIG. 14 illustrates different configuration settings 1405 corresponding to different preprocessing algorithms 1410,1410m followed by differently trained AI models 1415,1415m. Thus, the preprocessing algorithms 1410,1410m for the noisy channel image 1401 to be denoised per SRS may be switched based on the RRC configuration 1405, and different AI models 1415,1415m may be utilized for different sets of the configurations (e.g., different frequency bands, FR1, FR2). The outputs of the different AI models 1415,1415m may then undergo different postprocessing 1410,1420m.

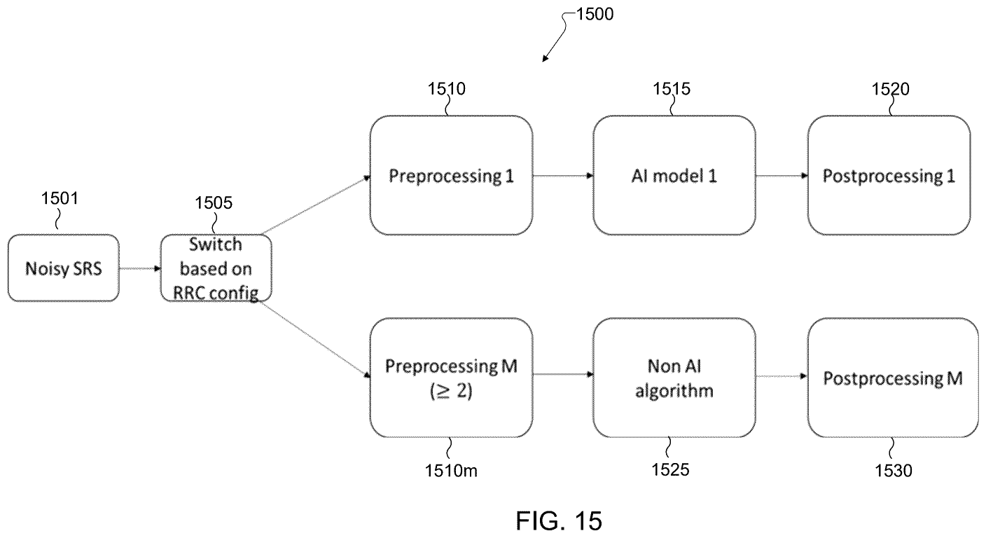

FIG. 15 illustrates one AI model 1515 pretrained only for a fixed configuration setting. In particular, a two-dimensional (2D) noisy channel image 1501 to be denoised per SRS may be of a fixed dimension (e.g., subcarriers×antenna) and the total number of subcarriers and the subcarrier spacing may be predefined. If the RRC configuration changes, then a non-AI algorithm 1525 may be triggered to be employed as a fallback. The denoised channels may then undergo corresponding postprocessing 1515,1530.

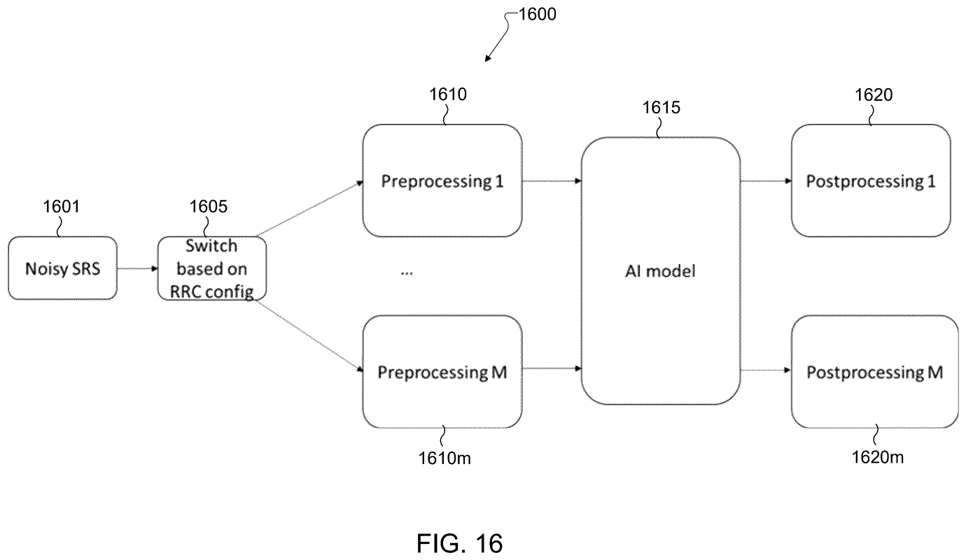

FIG. 16 illustrates different preprocessing algorithms 1610,1610m rendering the input to the AI model 1615 agnostic to the RRC configuration settings. Thus, there may be one AI model 1615, but the preprocessing algorithm 1610,1610m may vary for different configurations 1605 so as to make the output of each preprocessing algorithm 1610,1610m in a standardized format expected by the AI model 1615. The output from the AI model 1615, however, may undergo postprocessing 1620,1620m corresponding to the preprocessing algorithm 1610,1610m.

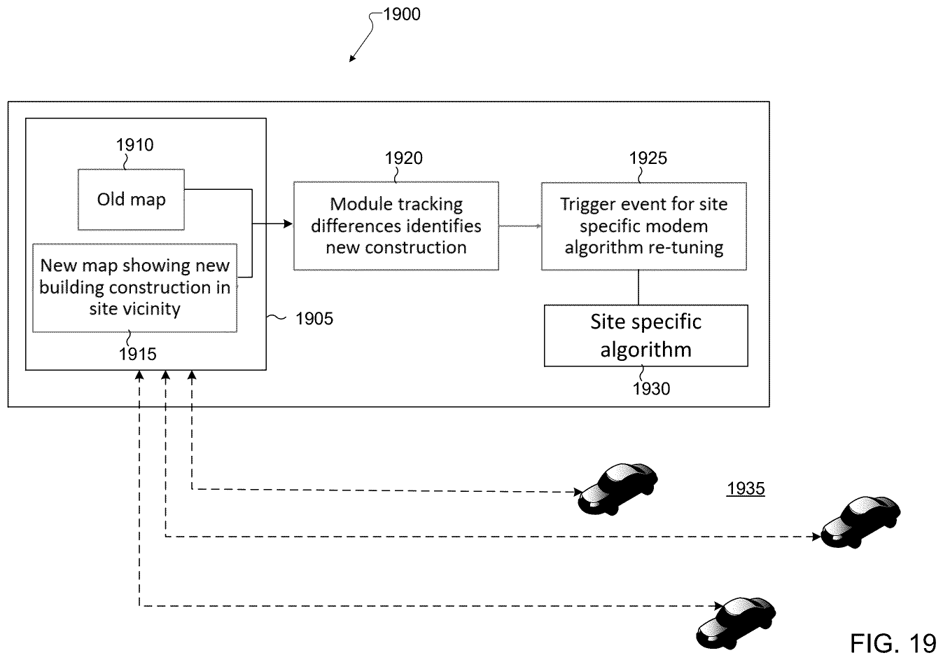

For example, the RRC configuration setting may include a 100 MHz total bandwidth in the 5G NR FR1 band. The subcarrier spacing may be, e.g., 30 KHz and the base station component (e.g., without limitation, a base station 101-103 of FIGS. 1 and 2 or a radio unit or distributed unit in an Open-RAN) that employs SRS CE may have 64 antennas. The SRS may operate with, e.g., a comb factor of 4 and cyclic shift (CS) 2 setting, and each SRS may cover a quarter of the total bandwidth. The AI model may receive an 2D image input having a dimension 204×64, where 204×30×4 KHz≈25 MHz. Thus, the AI model may be trained with this RRC setting. Following the preprocessing 1610,1610m of FIG. 19, the one AI model 1615 can work if the CS setting changes as long as the time domain windowing filter changes in the preprocessing as shown in FIG. 13.

Similarly, the same AI model 1615 can work if using the comb factor of 2. In this case, the input image dimension becomes 408×64. However, the 408 subcarriers with the comb-2 setting can be considered as two sets of 204 subcarriers with 120 KHz spacing (mimicking the comb-4 setting), and in this case the same AI model 1615 can work for each of the two sets of input data having the 204×64 dimension.

On the other hand, if a UE has radio link failures with the previous RRC configuration, the base station may recommend a frequency hopping mode for SRS transmission. In this case, the number of subcarriers and total bandwidth available may be smaller than 204, and a separately trained AI model 1410,1410m as illustrated in FIG. 14 may be needed or a non-AI model 1525 of FIG. 15 may be utilized as a fallback.

For the frequency hopping mode, if a delay in the SRS estimation is not a concern, then the received SRS data can be aggregated for different frequency hops until the whole bandwidth is covered, and then the data can be again broken down into a 204×64-dimension input for the AI model, thereby utilizing the originally trained AI model.

Similarly, the 64-antenna data may be split into two samples of 32 antenna data before feeding the data into the AI model for the following reasons:
The benefit of utilizing a larger number of antennas may become zero. The performance of a 64 antenna channel may be the same as the performance of a 32 antenna channel for TDL-A.
If more antennas (e.g., 256 antennas) are to be used, the data may be divided into a multiple 32-antenna datas to utilize the same SRS AI CE model.
Multiple 32-antenna datas can be evaluated sequentially or in parallel, depending on the available compute and GPU resources, thereby providing freedom in the operation of the SRS AI CE model.

It is noted that the number of antennas should not be reduced to a smaller number such as 8 or 4 since the performance of the AI CE model in terms of the NMSE may degrade. Thus, a sufficiently large number such as 32 may be selected.

In short, the AI model may be trained with a minimum prescribed input data size such as 204×32. If the input dimension is smaller than 204, oversampling (upsampling) as shown in FIG. 12 may be employed to bring the dimension to 204 before feeding the input to the AI model. In such case, the downsampling operation may not be performed.

Finally, if a new site is deployed, the configuration settings may change quite often for the gNB. In this case, the non-AI algorithms 1525 may be employed until stable configurations for the sites are identified. The AI models may be deployed after this phase (identification of the stable configurations), thereby offering the best performance identified for the configuration of that site.

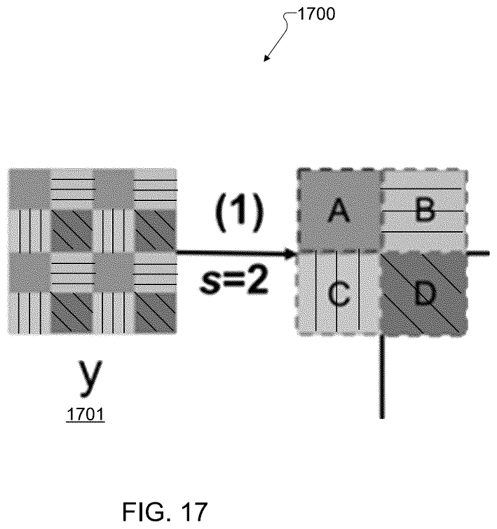

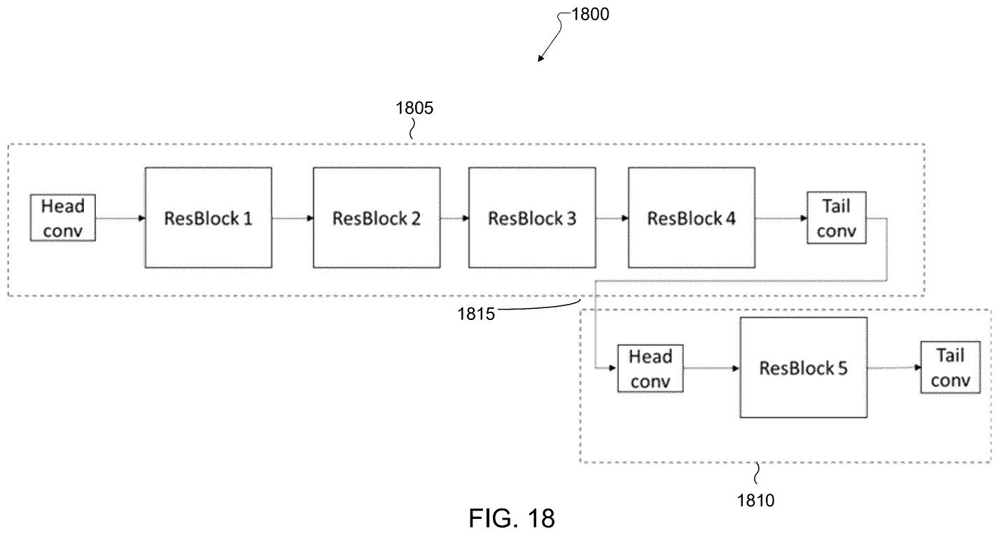

FIGS. 17-18 illustrate example site-specific data adaptation of an AI CE model according to example embodiments of the present disclosure.

FIG. 17 illustrates an example pixel shuffle downsampling 1700 for AI CE models according to embodiments of the present disclosure.

In one embodiment, the AI model trained with additive white Gaussian noise (AWGN) may be adapted for real noise, which may not be AWGN. In particular, the noise may be correlated across the antenna and subcarrier dimension for the input channel to the AI model. In this case, pixel shuffle downsampling of the noisy channel image may be performed utilizing a stride >=2. One of the key aspects that may vary in the real world data as compared to the AWGN independent samples per pixel (each pixel indicating a subcarrier-antenna pair) may be that the noise may not be independent, but correlated in the subcarrier and/or antenna dimension. Thus, the image 1701 to be denoised can be rearranged first into 4 subimages A, B, C, D. Denoising may then be performed separately for each subimage. Upon denoising, the image may be rearranged back to the original form.

FIG. 18 illustrates an example adaptation 1800 of an AI CE model according to embodiments of the present disclosure.

In order to deal with real noises, an AI model 1805 may be first trained with AWGN independently for each pixel or under some noise modeling assumptions, which may be identified a priori.

Then, when the real data becomes available, the AI model 1805 may remain in the same trained state as before, but a much smaller network 1810 may be appended to 1815 the AI model 1805. The smaller network 1810 may be then trained to adapt the overall output catering to the distribution of the real data.

It is noted that that in reality the real data that may be used for training may be in a much smaller order than the original network. Thus, a smaller AI model may be appended to avoid overfitting.

In one embodiment, the AI model may be pretrained with simulation data, and then the model parameters (transfer learning) may be updated as real data becomes available.

FIG. 19 illustrates example retraining of native AI models according to embodiments of the present disclosure. For retraining of the native AI models (not specific to ab SRS AI CE), a trigger event may be utilized.

Recently, autonomous driving as a new technology has been commercialized. Core to the workings of the autonomous driving may be the localization and mapping algorithms, where the vehicles may identify their precise locations within a centimeter accuracy on high definition maps. Typically, high definitions (HD) maps may be downloaded from remote servers or possibly coexist with the base station for enabling the accurate localization. These maps may need to get updated if the environment changes. These changes may include significant changes to static objects in surroundings such as a new construction in the surrounding, a new installation of a banner board, a highway or road construction in the neighborhood, or an opening of a new stadium or a mall that may affect wireless propagation environment statistics. They may not include dynamic or pseudo static obstacles that may move.

Such changes in the environment may be also indicative of a change in the propagation environment in the locality. Thus, an indicator that HD maps have been updated may be utilized as a trigger event for retraining the native AI models. A base station may obtain the HD map update information directly from the mapping servers or the maps could be updated by vehicles in motion (e.g., a moving smartphone on wheels) connected to the base station through the V2X communication. In the present disclosure, the update(s) of HD maps may be leveraged as an indicator to trigger retraining of the native AI models or start to collect data for retraining.

Referring back to FIG. 19, an electronic device (e.g., without limitation, a base station 101-103 of FIGS. 1 and 2, radio unit or distributed unit of Open-RAN) 1900 may include site-specific algorithms 1930 configured to perform at least one of scheduling, precoding or channel estimation. The electronic device 1900 may also include a mapping server 1905 including first maps 1910 for specified sites. The mapping server 1905 may be configured to gather sensor data from vehicles 1935 and generate second maps 1915 for the specified sites based on the sensor data. In some example, the mapping server 1905 may be located remotely from the electronic device 1900 and communicatively coupled thereto and configured to feed the HD maps to the electronic device 1900. The electronic device 1900 may further include a tracking device 1920 configured to identify differences between the first maps 1910 and the second maps 1915, and a triggering device 1925 configured to trigger retuning of the site-specific algorithms 1930 based on the differences. The site-specific algorithms 1930 may be any type of AI models or non-AI algorithms.

Thus, the present disclosure allows the electronic device 1900 to trigger retraining or retuning or the site-specific models or algorithms based on identified differences between the first and second maps as well as starting to collect data from the moving or stationary vehicles for the retraining or retuning.

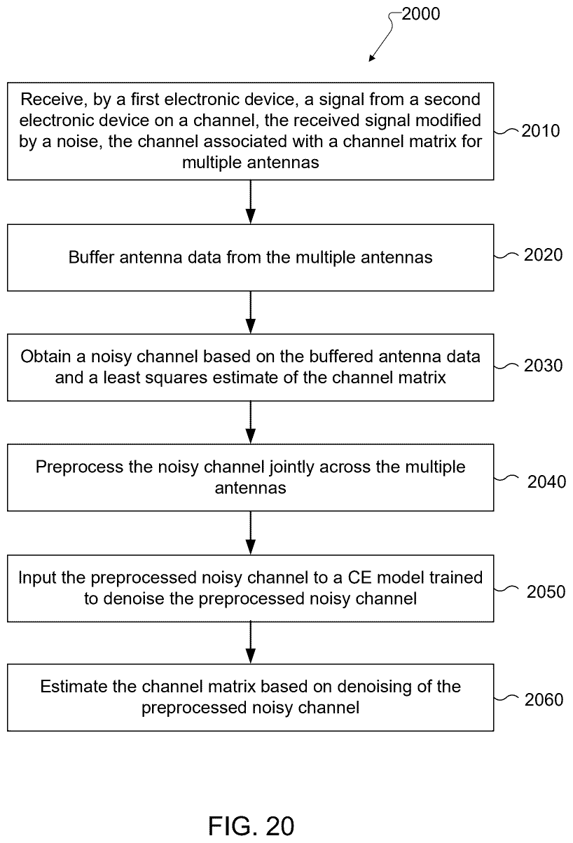

FIG. 20 illustrates an example flow chart for an AI-aided CE according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 20, the method 2000 begins at step 2010. At step 2010, a first electronic device (e.g., without limitation, a base station 101-103 of FIGS. 1 and 2, or radio unit or distributed unit of ORAN) may receive a signal from a second electronic device (e.g., without limitation, the UE 111-116 of FIGS. 1 and 3) on a channel, the received signal modified by a noise. The channel may be associated with a channel matrix for multiple antennas.

At step 2020, the first electronic device may buffer antenna data from the multiple antennas.

At step 2030, the first electronic device may obtain a noisy channel based on the buffered antenna data and a least squares estimate of the channel matrix.

At step 2040, the first electronic device may preprocess the noisy channel jointly across the multiple antennas. In one embodiment, preprocessing the noisy channel may further include transforming the noisy channel from a frequency-antenna domain to a delay-antenna domain, removing a target multiuser interference (MUI) from the noisy channel based on a cyclic shift window applied to the target MUI, performing a joint antenna timing offset (TO) estimation for the noisy channel, applying a timing compensation to the noisy channel based on the TO estimate, and converting the noisy channel from the delay-antenna domain to a delay-angular domain.

In one embodiment, preprocessing the noisy channel may further include upsampling the noisy channel with an image size greater than an input image size for the CE model, transforming the upsampled noisy channel from a frequency-antenna domain into a delay-antenna domain, removing a target MUI from the transformed noisy channel based on a cyclic shift window applied to the target MUI, performing joint antenna TO estimation for the MUI-removed noisy channel, applying a timing compensation to the MUI-removed noisy channel based on the TO estimate, downsampling the time-compensated noisy channel to the input image size for the CE model, and converting the noisy channel from the delay-antenna domain to a delay-angular domain.

At step 2050, the first electronic device may input the preprocessed noisy channel to a CE model trained to denoise the preprocessed noisy channel.

At step 2060, the first electronic device may estimate the channel matrix based on denoising of the preprocessed noisy channel.

In one embodiment, the method 2000 may further include training the CE model. Training the CE model may include receiving training data including a label and a noisy data, injecting a synthetic TO to the training data, preprocessing the noisy data in a delay domain to remove a multiuser interference, perform a joint antenna TO estimation, apply a timing compensation based on the joint TO estimation, downsample the time-compensated noisy data to an input image size for the CE model. Training the CE model may further include preprocessing the label to apply timing compensation based on the joint TO estimation on the noisy data, performing pixel shuffle downsampling on the noisy data; denoising the pixel shuffled noisy data; and computing a loss function based on a denoised output.

In one embodiment, the method 2000 may further include processing input data of an RRC configuration, generating one or more frequency-antenna two-dimensional noisy channels of a specified size based on the processed input data, preprocessing the generated noisy channels, inputting the generated noisy channels to the CE model, and estimating the channel matrix based on denoising of the generated noisy channels. The input data may be the same as the received signal. In some examples, the input data may be the same as the received signal with, e.g., without limitation, a different frequency bandwidth.

In one embodiment, the method 2000 may further include processing input data of an RRC configuration, generating one or more frequency-antenna two-dimensional noisy channels of a specified size based on the processed input data, preprocessing the generated noisy channels, determining that the CE model is not trained for the RRC configuration, inputting the generated noisy channels to a non-AI algorithm, and estimating the channel matrix based on denoising of the generated noisy channels.

In one embodiment, the method 2000 may further include processing input data of an RRC configuration, generating one or more frequency-antenna two-dimensional noisy channels of a specified size based on the processed input data, preprocessing the generated noisy channels, determining that the CE model is not trained for the RRC configuration, inputting the generated noisy channels to a different CE model trained for the RRC configuration, and estimating the channel matrix based on denoising of the generated noisy channels.

In one embodiment, the method 2000 may further include adapting to a site-specific field data. In one embodiment, adapting to a site-specific field data may include determining that neighboring pixels in the noisy channel have a correlated noise, and performing pixel shuffle downsampling. In one embodiment, adapting to a site-specific field data may include appending, to the CE model, a different CE model having smaller parameters than the CE model. The different CE model may be trained to operate with simulation data and field data.

In one embodiment, the first electronic device may include site-specific algorithms configured to perform at least one of scheduling, precoding or channel estimation, a mapping server including first maps for specified sites, a tracking device configured to identify differences between the first maps and the second maps, and a triggering device configured to trigger retuning of the site-specific algorithms based on the differences. The mapping server may be configured to gather sensor data from vehicles and generate second maps for the specified sites based on the sensor data.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method of channel estimation (CE), the method comprising:
receiving, by a first electronic device, a signal from a second electronic device on a channel, the received signal modified by a noise, the channel associated with a channel matrix for multiple antennas;
buffering antenna data from the multiple antennas;
obtaining a noisy channel based on the buffered antenna data and a least squares estimate of the channel matrix;
preprocessing the noisy channel jointly across the multiple antennas;
inputting the preprocessed noisy channel to a CE model trained to denoise the preprocessed noisy channel; and
estimating the channel matrix based on denoising of the preprocessed noisy channel.

2. The method of claim 1, further comprising training the CE model by:
receiving training data including a label and a noisy data;
injecting a synthetic timing offset (TO) to the training data;
preprocessing the noisy data in a delay domain to remove a multiuser interference, perform a joint antenna TO estimation, apply a timing compensation based on the joint TO estimation, and downsample the time-compensated noisy data to an input image size for the CE model;
preprocessing the label to apply timing compensation based on the joint TO estimation on the noisy data;
performing pixel shuffle downsampling on the noisy data;
denoising the pixel shuffled noisy data; and
computing a loss function based on a denoised output.

3. The method of claim 1, wherein preprocessing the noisy channel further comprises:
transforming the noisy channel from a frequency-antenna domain to a delay-antenna domain;
removing a target multiuser interference (MUI) from the noisy channel based on a cyclic shift window applied to the target MUI;
performing a joint antenna timing offset (TO) estimation for the noisy channel;
applying a timing compensation to the noisy channel based on the TO estimate; and
converting the noisy channel from the delay-antenna domain to a delay-angular domain.

4. The method of claim 1, wherein preprocessing the noisy channel further comprises:
upsampling the noisy channel with an image size greater than an input image size for the CE model;
transforming the upsampled noisy channel from a frequency-antenna domain into a delay-antenna domain;
removing a target multiuser interference (MUI) from the transformed noisy channel based on a cyclic shift window applied to the target MUI;
performing joint antenna timing offset (TO) estimation for the MUI-removed noisy channel;
applying a timing compensation to the MUI-removed noisy channel based on the TO estimate;
downsampling the time-compensated noisy channel to the input image size for the CE model; and
converting the noisy channel from the delay-antenna domain to a delay-angular domain.

5. The method of claim 1,
wherein the method further comprises:
processing input data of a radio resource control (RRC) configuration;
generating one or more frequency-antenna two-dimensional noisy channels of a specified size based on the processed input data;
preprocessing the generated noisy channels;
inputting the generated noisy channels to the CE model; and
estimating the channel matrix based on denoising of the generated noisy channels, or
wherein the method further comprises:
processing input data of an RRC configuration;
generating one or more frequency-antenna two-dimensional noisy channels of a specified size based on the processed input data;
preprocessing the generated noisy channels;
determining that the CE model is not trained for the RRC configuration;
inputting the generated noisy channels to a non-artificial intelligence algorithm; and
estimating the channel matrix based on denoising of the generated noisy channels, or
wherein the method further comprises:
processing input data of an RRC configuration;
generating one or more frequency-antenna two-dimensional noisy channels of a specified size based on the processed input data;
preprocessing the generated noisy channels;
determining that the CE model is not trained for the RRC configuration;
inputting the generated noisy channels to a different CE model trained for the RRC configuration; and
estimating the channel matrix based on denoising of the generated noisy channels.

6. The method of claim 1, further comprising:
adapting to a site-specific field data,
wherein adapting to the site-specific field data comprises:
determining that neighboring pixels in the noisy channel have a correlated noise; and
performing pixel shuffle downsampling, or
wherein adapting to the site-specific field data comprises:
appending, to the CE model, a different CE model having smaller parameters than the CE model, the different CE model trained to operate with simulation data and field data.

7. The method of claim 1, wherein the first electronic device comprises:
site-specific algorithms configured to perform at least one of scheduling, precoding or channel estimation;
a mapping server including first maps for specified sites, the mapping server configured to gather sensor data from vehicles and generate second maps for the specified sites based on the sensor data;
a tracking device configured to identify differences between the first maps and the second maps; and
a triggering device configured to trigger retuning of the site-specific algorithms based on the differences.

8. A first electronic device comprising:
memory; and
a processor operably coupled to the memory, the processor configured to:
receive a signal from a second electronic device on a channel, the received signal modified by a noise, the channel associated with a channel matrix for multiple antennas;
buffer antenna data from the multiple antennas;
obtain a noisy channel based on the buffered antenna data and a least squares estimate of the channel matrix;
preprocess the noisy channel jointly across the multiple antennas;
input the preprocessed noisy channel to a CE model trained to denoise the preprocessed noisy channel; and
estimate the channel matrix based on denoising of the preprocessed noisy channel.

9. The first electronic device of claim 8,
wherein the processor is further configured to train the CE model, and
wherein to train the CE model, the processor is further configured to:
receive training data including a label and a noisy data;
inject a synthetic timing offset (TO) to the training data;
preprocess the noisy data in a delay domain to remove a multiuser interference, perform a joint antenna TO estimation, apply a timing compensation based on the joint TO estimation, and downsample the time-compensated noisy data to an input image size for the CE model;
preprocess the label to apply timing compensation based on the joint TO estimation on the noisy data;
perform pixel shuffle downsampling on the noisy data;
denoise the pixel shuffled noisy data; and
compute a loss function based on a denoised output.

10. The first electronic device of claim 8, wherein to preprocess the noisy channel, the processor is further configured to:
transform the noisy channel from a frequency-antenna domain to a delay-antenna domain;
remove a target multiuser interference (MUI) from the noisy channel based on a cyclic shift window applied to the target MUI;
perform a joint antenna timing offset (TO) estimation for the noisy channel;
apply a timing compensation to the noisy channel based on the TO estimate; and
convert the noisy channel from the delay-antenna domain to a delay-angular domain.

11. The first electronic device of claim 8, wherein to preprocess the noisy channel, the processor is further configured to:
upsample the noisy channel with an image size greater than an input image size for the CE model;
transform the upsampled noisy channel from a frequency-antenna domain into a delay-antenna domain;
remove a target multiuser interference (MUI) from the transformed noisy channel based on a cyclic shift window applied to the target MUI;
perform joint antenna timing offset (TO) estimation for the MUI-removed noisy channel;
apply a timing compensation to the MUI-removed noisy channel based on the TO estimate;
downsample the time-compensated noisy channel to the input image size for the CE model; and
convert the noisy channel from the delay-antenna domain to a delay-angular domain.

12. The first electronic device of claim 8,
wherein the processor is further configured to:
process input data of a radio resource control (RRC) configuration;
generate one or more frequency-antenna two-dimensional noisy channels of a specified size based on the processed input data;
preprocess the generated noisy channels;
input the generated noisy channels to the CE model; and
estimate the channel matrix based on denoising of the generated noisy channels, or
wherein the processor is further configured to:
process input data of an RRC configuration;
generate one or more frequency-antenna two-dimensional noisy channels of a specified size based on the processed input data;
preprocess the generated noisy channels;
determine that the CE model is not trained for the RRC configuration;
input the generated noisy channels to a non-artificial intelligence algorithm; and
estimate the channel matrix based on denoising of the generated noisy channels, or
wherein the processor is further configured to:
process input data of an RRC configuration;
generate one or more frequency-antenna two-dimensional noisy channels of a specified size based on the processed input data;
preprocess the generated noisy channels;
determine that the CE model is not trained for the RRC configuration;
input the generated noisy channels to a different CE model trained for the RRC configuration; and
estimate the channel matrix based on denoising of the generated noisy channels.

13. The first electronic device of claim 8,
wherein the processor is further configured to adapt to a site-specific field data,
wherein to adapt to the site-specific field data, the processor is further configured to:
determine that neighboring pixels in the noisy channel have a correlated noise; and
perform pixel shuffle downsampling, or
wherein to adapt to the site-specific field data, the processor is further configured to:
append, to the CE model, a different CE model having smaller parameters than the CE model, the different CE model trained to operate with simulation data and field data.

14. The first electronic device of claim 8, further comprising:
site-specific algorithms configured to perform at least one of scheduling, precoding or channel estimation;
a mapping server including first maps for specified sites, the mapping server configured to gather sensor data from vehicles and generate second maps for the specified sites based on the sensor data;
a tracking device configured to identify differences between the first maps and the second maps; and
a triggering device configured to trigger retuning of the site-specific algorithms based on the differences.

15. A non-transitory computer readable medium embodying a computer program, the computer program comprising program code that, when executed by a processor of a first electronic device, causes the first electronic device to:
receive a signal from a second electronic device on a channel, the received signal modified by a noise, the channel associated with a channel matrix for multiple antennas;
buffer antenna data from the multiple antennas;
obtain a noisy channel based on the buffered antenna data and a least squares estimate of the channel matrix;
preprocess the noisy channel jointly across the multiple antennas;
input the preprocessed noisy channel to a CE model trained to denoise the preprocessed noisy channel; and
estimate the channel matrix based on denoising of the preprocessed noisy channel.

16. The non-transitory computer readable medium of claim 15,
wherein the computer program further comprises program code that, when executed by the processor of the first electronic device, causes the first electronic device to train the CE model, and
wherein the program code that, when executed by the processor of the electronic device, causes the first electronic device to train the CE model comprises program code that, when executed by the processor of the first electronic device, causes the first electronic device to:
receive training data including a label and a noisy data;
inject a synthetic timing offset (TO) to the training data;
preprocess the noisy data in a delay domain to remove a multiuser interference, perform a joint antenna TO estimation, apply a timing compensation based on the joint TO estimation, and downsample the time-compensated noisy data to an input image size for the CE model;
preprocess the label to apply timing compensation based on the joint TO estimation on the noisy data;
perform pixel shuffle downsampling on the noisy data;
denoise the pixel shuffled noisy data; and
compute a loss function based on a denoised output.

17. The non-transitory computer readable medium of claim 15, wherein the program code that, when executed by the processor of the first electronic device, causes the first electronic device to preprocess the noisy channel comprises program code that, when executed by the processor of the first electronic device, causes the first electronic device to:
transform the noisy channel from a frequency-antenna domain to a delay-antenna domain;
remove a target multiuser interference (MUI) from the noisy channel based on a cyclic shift window applied to the target MUI;
perform a joint antenna timing offset (TO) estimation for the noisy channel;
apply a timing compensation to the noisy channel based on the TO estimate; and
convert the noisy channel from the delay-antenna domain to a delay-angular domain.

18. The non-transitory computer readable medium of claim 15, wherein the program code that, when executed by the processor of the first electronic device, causes the first electronic device to preprocess the noisy channel comprises program code that, when executed by the processor of the first electronic device, causes the first electronic device to:
upsample the noisy channel with an image size greater than an input image size for the CE model;
transform the upsampled noisy channel from a frequency-antenna domain into a delay-antenna domain;
remove a target multiuser interference (MUI) from the transformed noisy channel based on a cyclic shift window applied to the target MUI;
perform joint antenna timing offset (TO) estimation for the MUI-removed noisy channel;
apply a timing compensation to the MUI-removed noisy channel based on the TO estimate;
downsample the time-compensated noisy channel to the input image size for the CE model; and
convert the noisy channel from the delay-antenna domain to a delay-angular domain.

19. The non-transitory computer readable medium of claim 15,
wherein the computer program further comprises program code that, when executed by the processor of the first electronic device, causes the first electronic device to:
process input data of a radio resource control (RRC) configuration;
generate one or more frequency-antenna two-dimensional noisy channels of a specified size based on the processed input data;
preprocess the generated noisy channels;
input the generated noisy channels to the CE model; and
estimate the channel matrix based on denoising of the generated noisy channels, or
wherein the computer program further comprises program code that, when executed by the processor of the first electronic device, causes the first electronic device to:
process input data of an RRC configuration;
generate one or more frequency-antenna two-dimensional noisy channels of a specified size based on the processed input data;
preprocess the generated noisy channels;
determine that the CE model is not trained for the RRC configuration;
input the generated noisy channels to a non-artificial intelligence algorithm; and
estimate the channel matrix based on denoising of the generated noisy channels, or
wherein the computer program further comprises program code that, when executed by the processor of the first electronic device, causes the first electronic device to:
process input data of an RRC configuration;
generate one or more frequency-antenna two-dimensional noisy channels of a specified size based on the processed input data;
preprocess the generated noisy channels;
determine that the CE model is not trained for the RRC configuration;
input the generated noisy channels to a different CE model trained for the RRC configuration; and
estimate the channel matrix based on denoising of the generated noisy channels.

20. The non-transitory computer readable medium of claim 15,
wherein the computer program further comprises program code that, when executed by the processor of the first electronic device, causes the first electronic device to adapt to a site-specific field data,
wherein the program code that, when executed by the processor of the first electronic device, causes the first electronic device to adapt to a site-specific field data comprises program code that, when executed by the processor of the first electronic device, causes the first electronic device to:
determine that neighboring pixels in the noisy channel have a correlated noise; and
perform pixel shuffle downsampling, or
wherein the program code that, when executed by the processor of the first electronic device, causes the first electronic device to adapt to a site-specific field data comprises program code that, when executed by the processor of the first electronic device, causes the first electronic device to:
append, to the CE model, a different CE model having smaller parameters than the CE model, the different CE model trained to operate with simulation data and field data.
